(19) United States
(12) Patent Application Publication
(10) Pub. No.: US 2026/0059302 A1
(43) Pub. Date: Feb. 26, 2026

(54) Method and Device for Radio Communication of Encrypted PPM Signals

(71) Applicant: STE Industries S.R.L., Milano (IT)

(72) Inventors: Paolo Maria Moiraghi, Marcignago (IT); Nicola Vito Mazzacane, Milano (IT)

(21) Appl. No.: 18/998,676

(22) PCT Filed: Jul. 27, 2023
(86) PCT No.: PCT/EP2023/070834

§ 371 Date: Jan. 27, 2025

(30) Foreign Application Priority Data
Jul. 28, 2022 (IT) 102022000015990

(51) Int. Cl. H04W 12/037; H04L 25/49

(52) U.S. Cl. CPC H04W 12/037; H04L 25/4902

(57) ABSTRACT

Methods and devices for the communication of encrypted PPM signals for a radio communication system. There is a step of PPM encoding of an information item to be transmitted in which each symbol of an alphabet of symbols used to compose the information item to be transmitted is assigned a respective predefined temporal position of one pulse with respect to the preceding pulse of an original sequence of PPM pulses. There is a step of encryption, particularly at the physical layer, wherein at least one of the pulses of the transmitted sequence is time-shifted, according to a corresponding offset that is known only to authorized receivers, with respect to its predefined temporal position in the original sequence. The offset is such that the time-shifted pulse is not located, with respect to the pulse that precedes it, in any of the predefined temporal positions that are provided in the PPM encoding.

The present invention relates to a method and a device for radio communication of encrypted PPM signals, in particular for telemetry applications. Specifically, the invention relates to a method of transmission, a method of reception, a transmitter and a receiver of such signals.

With the PPM signal encrypted according to the invention, values of measurements—carried out locally—of physical quantities, for example values of pressure, temperature, humidity, deformation, vibration or the like, collected using adapted sensors on structures, for example, rotating, oscillating or vibrating structures, can be transmitted.

A specific, but non exclusive, use of the invention is the telemetry of vehicles, for example use of the device on tires to transmit their internal pressure by radio (Tire Pressure Monitoring System—TPMS) or other physical quantities or parameters measured on the tire or on the wheel that carries it. However, the present invention is not limited to the sector of vehicles or of tires, but is adapted to be used in any context wherein a measurement carried out locally of a certain physical quantity or parameter needs to be transmitted by low-energy radio and/or by short-range radio.

In the state of the art devices for the transmission of measurements of physical values such as temperature, pressure, humidity, deformation, etc. are known, which are capable of converting such measurements, carried out locally, to data strings that are then transmitted by radio.

In order to appreciably reduce the energy consumption of these transmission devices, a transmitter device is known, for example from U.S. Pat. No. 10,284,120, which comprises a microcontroller configured to receive a signal relating to at least one value measured locally and to control a pulse generator so as to generate a corresponding signal modulating the position of the pulse (Pulse Position Modulation, PPM) which is then transmitted by radio. The pulse generator according to this known solution comprises an oscillator and a power amplifier for amplifying the pulses in output from the oscillator and for emitting the radiofrequency PPM signal. The microcontroller is configured, for each pulse of the PPM signal to be generated, to activate only the oscillator for a first time period and then to activate the amplifier as well only for a second time period after the start of the first time period, and to deactivate both of them at the same time at the end of the second time period.

The PPM encoding of the information to be transmitted, which contains the values that were measured locally, entails assigning to each symbol of M bits (for example 4 bits) of an alphabet of 2\hat{ }M symbols (for example 16 symbols with M=4), that is used to compose the information item to be transmitted, a respective predefined temporal position of a PPM pulse with respect to the preceding pulse of a sequence of PPM pulses that is transmitted.

Such a technique of encoding is not without drawbacks, which include the risk of eavesdropping of the radio signal with attendant possibility of the message being decoded, which can be easy once the correspondence between relative distance and binary symbol is determined from the analysis of the sequence of the intercepted pulses.

Furthermore, it is possible that only a single receiver out of several receivers adapted to decode the PPM signal can be the intended recipient of the message broadcast with this signal, which therefore must not be decodable by another receiver. Also, a receiver could after some time be no longer authorized to decode some or all of the PPM signals of a given transmitter.

US 2017/0150347 A1 discloses to apply a key-modified slot index to a PPM plain baseband signal so as to incrementally change the slot index to which each pulse of the plain baseband signal is assigned.

The aim of the present invention is to provide a method and a device for radio communication of PPM signals, that are capable of improving the known art in one or more of the above mentioned aspects.

Within this aim, an object of the invention is to provide a method and a device for radio communication, particularly short-range radio communication, of PPM signals, that are adapted to increase the security of radio communications, while preventing or appreciably reducing the risk of an unauthorized decoding of the transmitted PPM signals.

Another object of the invention is to prevent or reduce the risk of an unauthorized decoding of the transmitted PPM signals while keeping energy consumption low.

Another object of the invention is to enable a secure radio communication of PPM signals that does not require high processing speeds or clock speeds.

Another object of the invention is to make it possible to straightforwardly add to, or remove from, receivers of PPM signals authorization for PPM decoding.

Furthermore, the present invention sets out to overcome the drawbacks of the background art in a manner that is alternative to any existing solutions.

Another object of the invention is to provide a communication method and device that are highly reliable, easy to implement and of low cost.

This aim and these and other objects which will become more apparent hereinafter are achieved by a method of transmission according to claim 1, by a method of reception according to claim 8, by means of a transmitter according to claim 13 and by means of a receiver according to claim 19, optionally provided with one or more of the characteristics of the dependent claims.

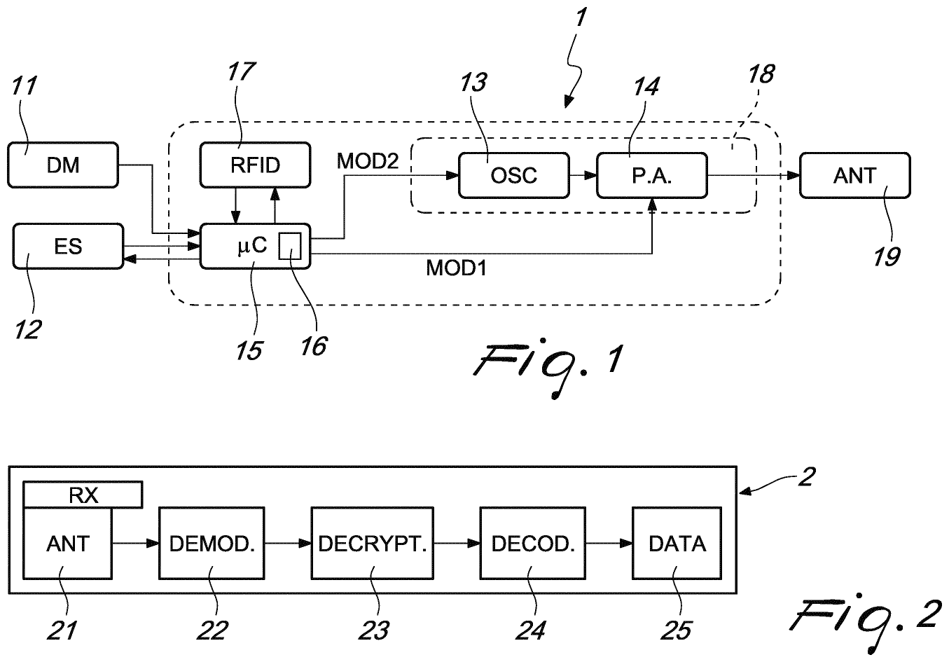

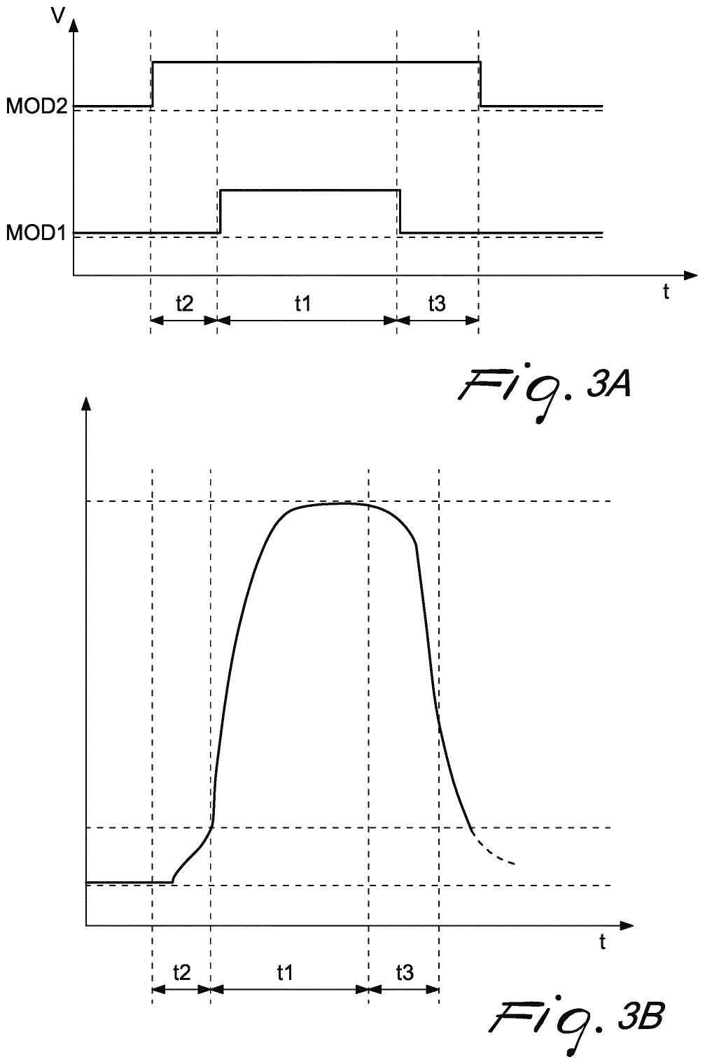

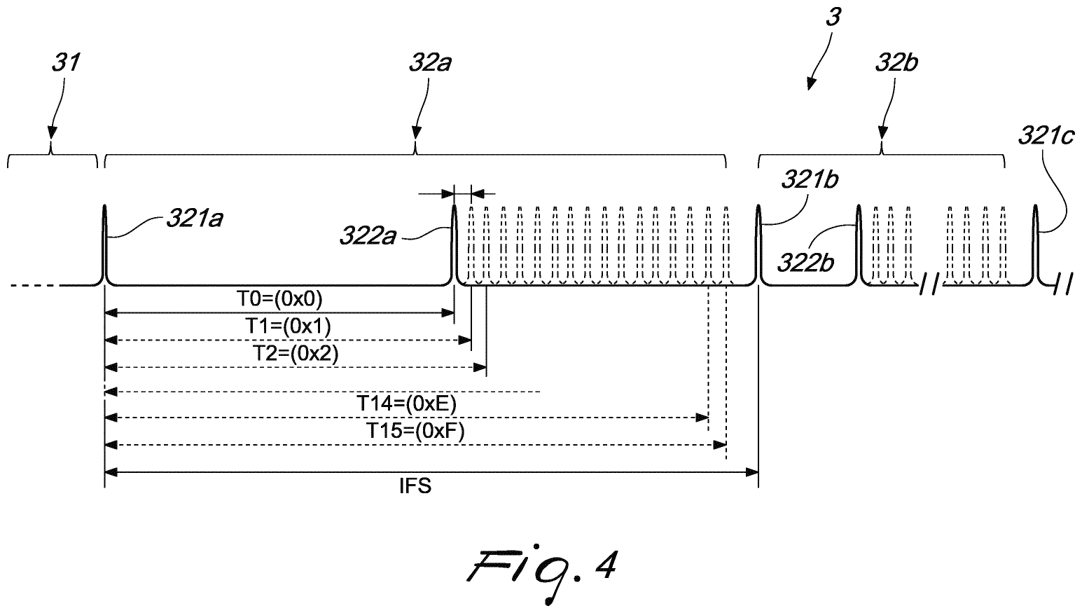

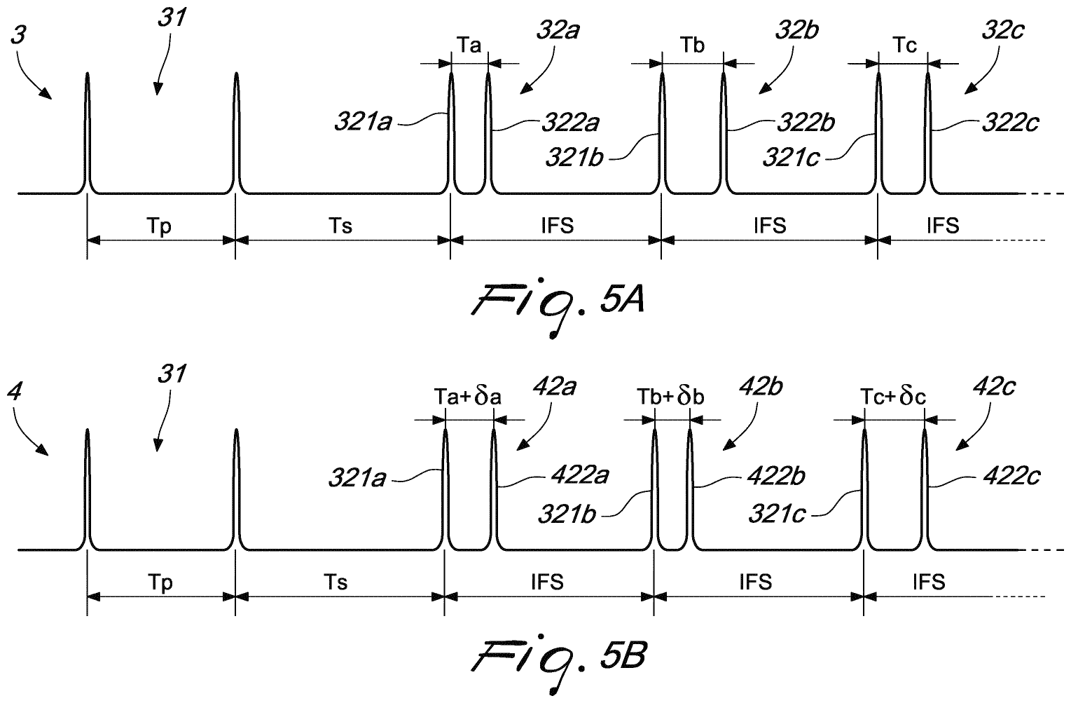

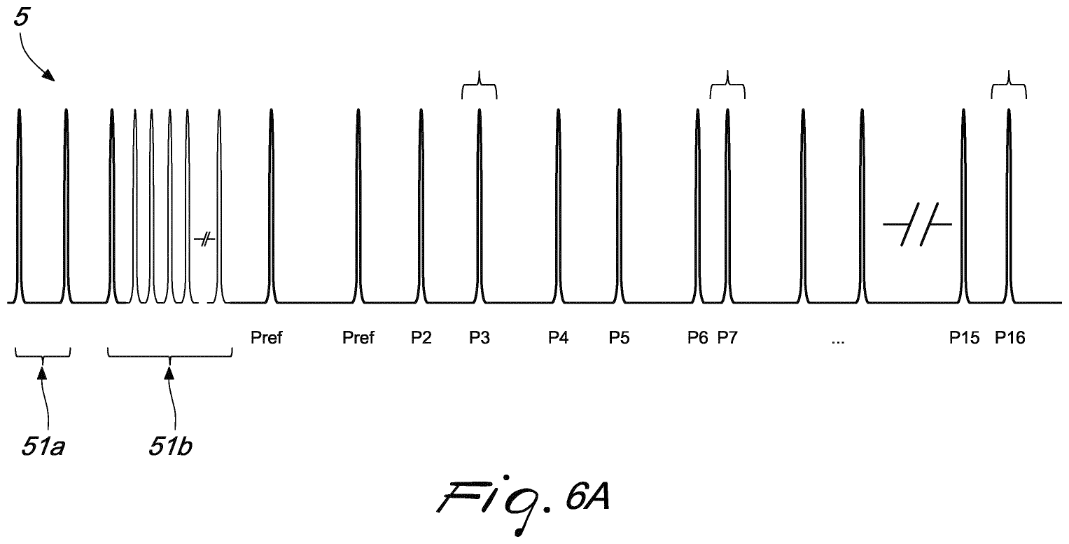

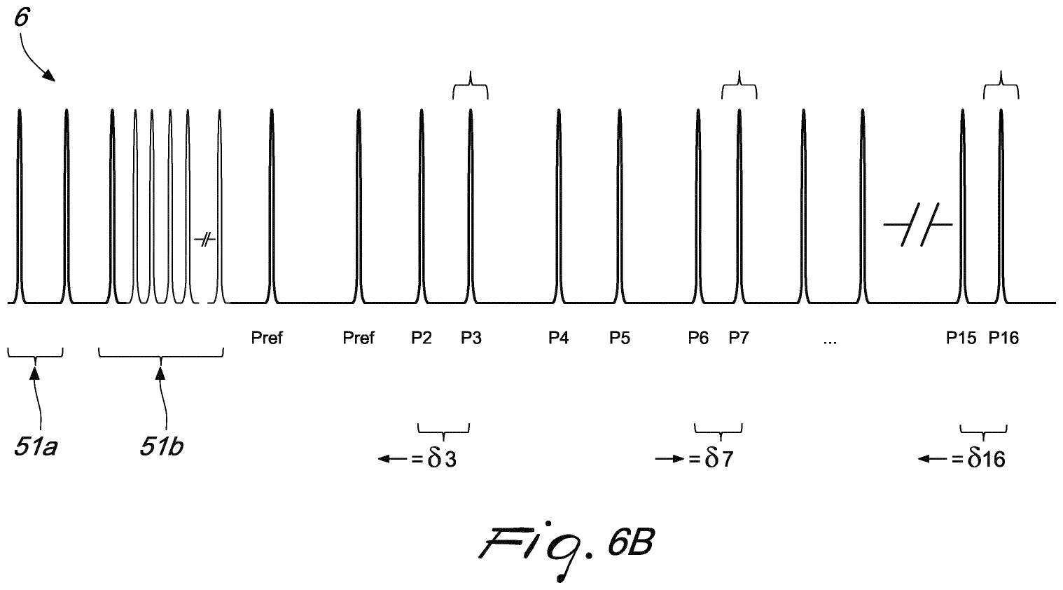

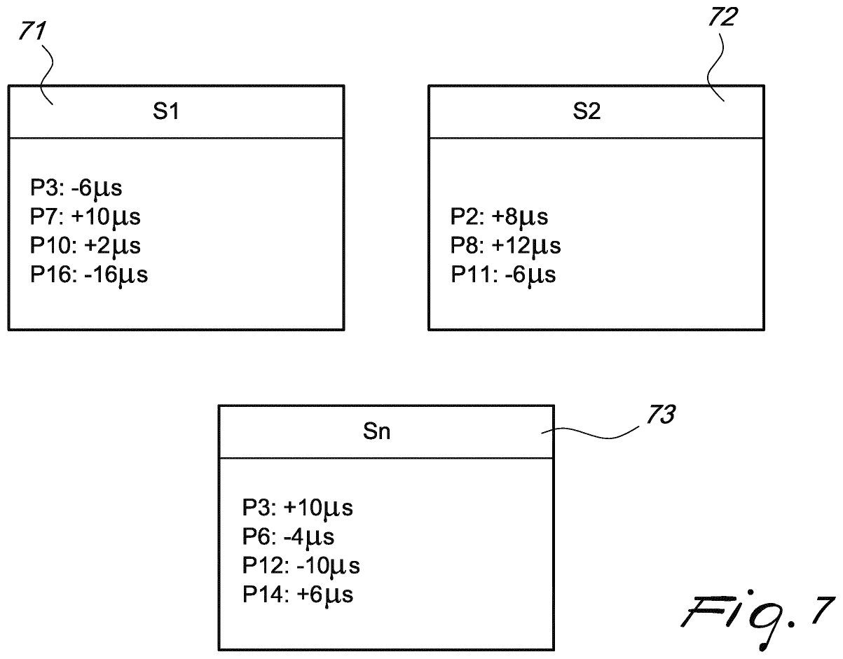

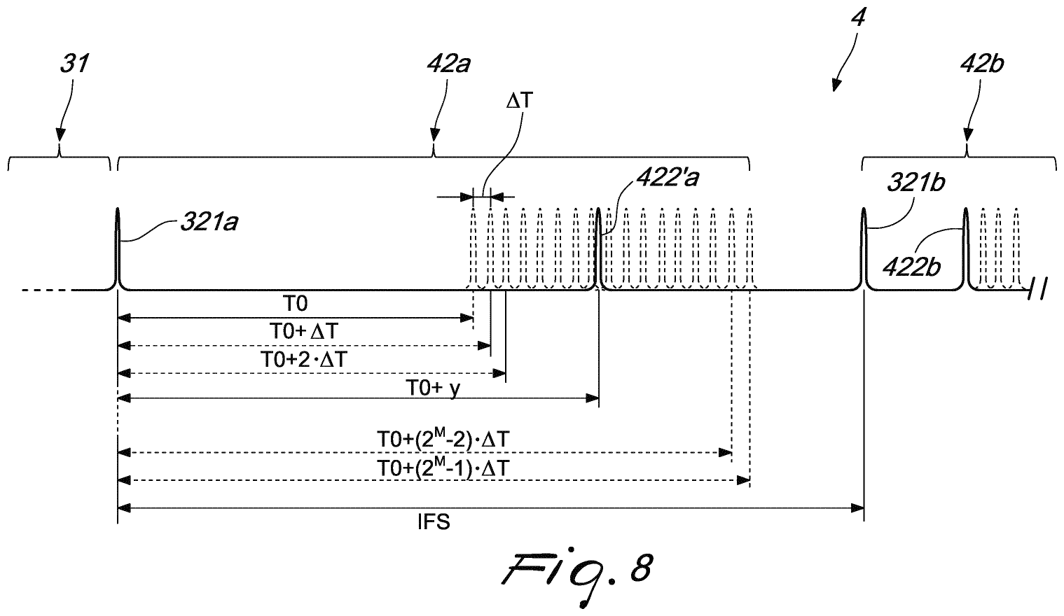

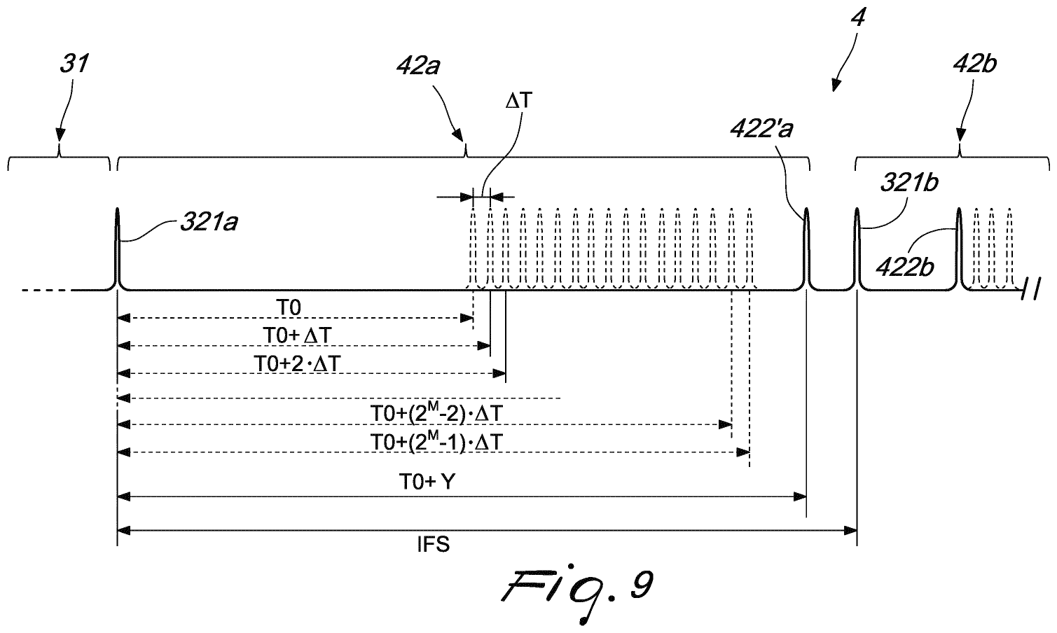

Further characteristics and advantages of the invention will become better apparent from the description of preferred, but not exclusive, embodiments of the invention, illustrated by way of non-limiting example in the accompanying drawings wherein:
FIG. 1 is a block diagram of a transmitter according to the invention;
FIG. 2 is a block diagram of a receiver according to the invention;
FIG. 3A shows the step-like control signals of the oscillator and of the power amplifier of the transmitter of FIG. 1;
FIG. 3B shows a PPM pulse obtained at the exit of the power amplifier of FIG. 1;
FIG. 4 shows a sequence of PPM pulses with the possible encodings of 4-bit symbols;
FIG. 5A shows an original sequence of PPM pulses processed in PPM encoding;
FIG. 5B shows an encrypted sequence starting from the sequence of FIG. 5A and which is transmitted;
FIG. 6A shows another original sequence of PPM pulses processed in PPM encoding, which incorporates a public key of the receiver in the preamble;
FIG. 6B shows an encrypted sequence starting from the sequence of FIG. 6A and which is transmitted;
FIG. 7 is an example of sets of shift information items used for encryption
FIG. 8 shows an encrypted sequence in which a PPM pulse is time-shifted with an offset according to an embodiment of the invention;
FIG. 9 shows an encrypted sequence in which a PPM pulse is time-shifted with an offset according to another embodiment of the invention.

With reference to the figures, a device for the radio transmission of encrypted PPM signals according to an embodiment of the invention, particularly for telemetry applications, is generally designated by the reference numeral 1 and comprises a microcontroller 15 and pulse generation means 18 which are connected to the microcontroller 15, so as to be controlled by the latter. The transmission device 1 is advantageously a short-range device powered by an energy source 12, for example a battery or an energy harvesting source.

The microcontroller 15 is preferably adapted to receive in input one or more detection signals which represent one or more measurement values of one or more physical quantities. The microcontroller 15 is, furthermore, adapted to control the pulse generation means 18 so that they generate PPM (Pulse Position Modulation) signals which comprise, in encoded form, information corresponding to the measurement values received by the microcontroller 15 via the detection signals. However, the method of transmission and reception according to the invention can be applied in general to any device for radio communication of PPM pulses, for any applications and not necessarily for telemetry.

The pulse generation means 18 are connected in output, through an optional impedance adaptation stage, to an antenna 19 for radio transmitting the PPM signals generated by the pulse generation means 18, so that the PPM signals are received by radio by a remote receiver 2.

The detection signals originate from detection means 11 which are, for example, connected or can be connected to the microcontroller 15 and which are adapted to detect one or more measurements of a certain physical quantity (for example, one or more of pressure, temperature, acceleration, vibration, voltage, etc.) and to generate detection signals that correspond to the (transduced) values of such measurements. The detection means 11 can consist substantially of at least one transducer (“DM” in the figures) for each physical quantity to be measured. The transducer DM can be connected to a suitable input of the microcontroller 15 and can be a sensor selected from the group comprising, for example, a pressure sensor, a temperature sensor, a vibration sensor, an accelerometer, a magnetometer, a strain gauge, an inductive sensor, a voltage or current detector, etc.

The detection means 11, and also an optional RFID tag 17 of the transmission device 1, can optionally be powered by the microcontroller 15 itself.

The pulse generation means 18 comprise an oscillator 13 the output of which is connected to the input of a power amplifier (“P.A.”) 14, so that the latter will amplify the radiofrequency (or “RF”) signals emitted by the oscillator 13 and generate in output the PPM pulses that will be radio transmitted. The gain of the power amplifier 14 can be comprised between 10 and 20. These pulse generation means 18 and their method of control can be known per se, for example from U.S. Pat. No. 10,284,120, optionally improved as shown in FIGS. 3A and 3B.

The oscillator 13 of the pulse generation means 18 preferably comprises a Colpitts oscillator in a “common base” configuration and coupled to a SAW (Surface Acoustic Wave) resonator, which allows said oscillator 13 to achieve a stable radiofrequency value (e.g. 434.35 MHz). The oscillator 13 is of a per se known type, for example from U.S. Pat. No. 8,134,416 B2, incorporated herein by reference. As an alternative, the oscillator 13 can be a Hartley oscillator in a “common emitter” configuration and coupled to the SAW resonator.

The microcontroller 15 can be a microcontroller with a low clock speed, for example of the order of 1 MHz, and programmed to generate on its corresponding outputs a first signal MOD1 to drive the power amplifier 14 and a second signal MOD2 to drive the oscillator 13. The signals MOD1 and MOD2 substantially consist of rectangular pulses of voltage or current (concurrent with each other but of different durations), i.e. of signals that take only a low value (nil) and a high value. Each PPM pulse to be transmitted corresponds to a single rectangular pulse of the first signal MOD1 and a single rectangular pulse of the second signal MOD2 that is substantially concurrent with the pulse of MOD1 and of greater duration. The microcontroller 15 is configured, for each pulse of the PPM signal to be generated, to activate with MOD2 only the oscillator 13 for a first time period t2 (corresponding to the high level of MOD2) and then to activate also the amplifier 14 with MOD1 only for a second time period t1 while MOD2 remains high, deactivating both of them at the end of the second time period t1 or, as in FIG. 3A, deactivating first MOD1 and leaving only MOD2 high for a third time period t3.

According to the preferred embodiment of the invention, the microcontroller 15 comprises encoding means for encoding the information received from the detection means 11 into an original sequence of PPM pulses or into a sequence of relative distances between pulses to be radio transmitted.

The receiver 2 comprises an antenna 21 connected to a demodulator 22 and to means 23-24 for reconstructing the information 25 contained in the encrypted PPM signal received by the antenna 21. The demodulator 22 can be per se known (for example from U.S. Pat. No. 9,270,309) and can comprise, in cascade, a first stage for low-noise amplification of the modulated radiofrequency signal originating from the antenna 21, a SAW band-pass filter around a predefined frequency, a logarithmic amplifier adapted to amplify the signal that arrives from the SAW filter, and a peak detector of the output signal from the logarithmic amplifier. The above mentioned means for reconstructing the information are adapted to decode the PPM signal on the basis of the sequence of PPM pulses in output preferably from the logarithmic amplifier and optionally on the basis of the signal, indicating the strength of the PPM signal received by the antenna, in output from the peak detector.

The means for reconstructing the information according to the invention can be made up of a microcontroller and comprise, in addition to decoding means 24 that are per se known, decryption means 23 according to the invention.

The remote receiver 2 can be located at a short distance from the transmission device 1, for example on board of the same vehicle on which one or more transducers DM are mounted.

In the PPM encoding carried out by the encoding means of the microcontroller 15, each M-bit symbol of an alphabet of 2\hat{ }M binary symbols used to encode and compose the information to be transmitted (for example the information contained in the signals originating from the detection means 11) is assigned a respective predefined temporal position of one pulse with respect to the preceding pulse of an original sequence of PPM pulses, i.e. a predefined relative temporal distance (T0, T1, T2, . . .) is assigned for each pair of consecutive pulses of the original sequence. By “original” sequence is meant the sequence of pulses (indicated with 3 or 5 in the figures) that, once transmitted by radio, can be decoded by a receiver without a key and knowing only the points of correspondence between the symbols and the predefined relative temporal distances of the scheme applied by the transmitter 1 to carry out the PPM encoding. The sequence of analog pulses in output from the pulse generation means 18 corresponds, in terms of relative temporal distances T0, T1, . . . to the sequence of “rectangular” pulses appropriately generated by the microcontroller 15 through the signals MOD1 and MOD2 in order to switch on/switch off the pulse generator 18.

In the embodiments illustrated here, the symbols can be 4-bit (M=4) symbols and therefore the 16 symbols of the alphabet can be encoded with 16 different predefined temporal positions T0, T1, . . . , T15 of one pulse 322a, 322b, 322c, . . . with respect to the immediately preceding pulse 321a, 321b, 321c, . . . In this specific case, a pair of pulses therefore represents a half-byte or “nibble”.

The pulses (321a, 322a, 321b, 322b, 321c, 322c, . . . ) that are generated by the pulse generation means 18 in order to be radio transmitted preferably have a duration comprised between 1 and 5 microseconds (for example of 2 microseconds), and can have an amplitude that is quasi-Gaussian in shape as in FIG. 3B.

The encodings of the 2\hat{ }M symbols can be defined starting from a minimum temporal distance T0 (for example of 52 microseconds) corresponding to the first symbol of the alphabet (shown schematically in the figures with the hexadecimal symbol 0) to a maximum distance T15 (for example of 97 microseconds corresponding to the hexadecimal symbol F, for M=4 bits) with a constant increase in pitch AT between the minimum and the maximum (for example an increase of 3 microseconds between one temporal distance and the next).

In a first embodiment, the original sequence of pulses 3 is formed by a plurality of pairs of pulses 32a, 32b, 32c, . . . wherein the first pulse 321a, 321b, 321c, . . . of each pair (or “trigger pulse”) is generated periodically over time, for example every IFS microseconds (where IFS, “Intra-Frame Spacing”, is a fixed value, preferably comprised between 200 and 500 microseconds, for example 305 microseconds). Then the second pulse of each pair (or “data pulse”) is at temporal position T0, T1, T2, . . . with respect to the first pulse, which position is assigned by the PPM encoding on the basis of the binary symbol to encode and is therefore predefined. The duty-cycle of the pulses is very low, for example less than 5/100 (or approximately 1/100 in the case shown), so that the pulses are clearly distinguishable to the receiver 2 and the energy consumption is low.

In a second embodiment, the original sequence of pulses 5 can be considered as a succession of pairs of pulses but, in this case, the second pulse of each pair (for example the pulse in position P3, in the pair P2-P3) corresponds to the first pulse of the subsequent pair (P3-P4) in the sequence and the relative temporal distance defined by the PPM encoding is the distance between the second pulse (in position P3) and the immediately preceding pulse (in position P2). In this case too, the duration of each pulse is much less than the relative temporal distance between one pulse and the subsequent or preceding pulse; for example, it is between 2% and 5% of that duration.

In all the preferred embodiments, the sequence of pulses is preceded by a preamble 31 or 51a which serves to identify the start of the frame that contains the sequence of pulses. The preamble is also constituted by pulses of amplitude and duration preferably equal to that of the other pulses of the sequence. For example, the preamble 31 is constituted by two pulses which are at a fixed temporal distance Tp between them, at a fixed temporal distance Ts from the first pulse 321a of the sequence, and which have a much shorter duration with respect to such distances Tp or Ts (for example, with a ratio of 1 to 100 or less). In the example of a sequence of pulses at 2 microseconds, the distance Tp can be 225 microseconds and the distance Ts can be 305 microseconds, i.e. equal to the repetition period of the trigger pulses 321a, 321b, 321c, . . .

The transmitter 1 comprises encryption means 16 (for example programmed in the microcontroller 15) which are adapted to time-shift at least one of the pulses of the original sequence 3 or 5 (according to a corresponding offset 8 different from zero and known only to authorized receivers 2, for example because it is stored or can be obtained by these receivers) with respect to the predefined temporal position that this shifted pulse had in the original sequence 3 or 5, so that the transmitted pulse sequence comprises the at least one time-shifted pulse.

In this manner, the transmitted pulse sequence is illegible at an (unauthorized) receiver that is capable only of decoding the original PPM sequence and incapable of knowing the shift applied to one or more of the pulses.

The offset 8 is preferably defined so that the new temporal distance between the shifted pulse and the immediately preceding pulse of the sequence is uniquely different from all the temporal distances provided by the PPM encoding. In other words, the time-shifted pulse is not found in any of the predefined temporal positions provided by the PPM encoding. For example, if the PPM encoding specifies that each symbol of the alphabet corresponds to a pulse that is at a distance T0+n·ΔT from the preceding pulse, where T0 is a minimum temporal distance between two consecutive pulses (for example 52 microseconds, as in the example mentioned previously), n is an integer, and ΔT is a certain constant pitch (for example 3 microseconds), the absolute value of the offset 8 introduced with the encryption is, for at least one of the time-shifted pulses, different from this pitch ΔT and from a whole multiple of this pitch. Therefore, the value of the shift applied by the encryption means 16 is, for one or more of the pulses, outside the values or positions allowed by the PPM encoding protocol, so as to render the pair of pulses unreadable by an unauthorized receiver that knows the PPM encoding of the transmitter.

Advantageously, the offset 8 can also be defined so that the new temporal distance between the shifted pulse and the immediately preceding pulse of the sequence is the same for all the pulses of the message that encode the same symbol of the alphabet.

With the encryption according to the invention, the relative temporal distance is in practice modified between the two pulses of at least one pair of the original sequence 3 or 5, with a criterion or algorithm that is known only to the authorized receivers, for example because they have the decryption key or they have stored instructions for recognizing the encryption criterion used in the received sequence of pulses.

Considering that the encryption affects the pulses that are physically transmitted by radio, the encryption (or cryptography) according to the invention occurs advantageously at the physical layer of the OSI communication model, differently therefore from other cryptography techniques which are based on the data layer of the OSI model. By bringing the cryptography to the physical layer, the invention acts on the elements (the pulses) that constitute the message itself, that is to say on the modulation of the pulses that constitute the message. This makes it possible to render the message non receivable without a related key.

In the illustrated embodiments, a plurality of the pulses of the transmitted sequence are time-shifted by the encryption means 16 with respect to the respective predefined temporal position, with the corresponding offset having a value and/or a sign that is not the same for all the pulses of the plurality of time-shifted pulses.

In the first embodiment, the sequence 4 of PPM pulses that is transmitted has the second pulses 422a, 422b and 422c of the first three pairs located in a position that is shifted with respect to the position of the corresponding pulses 322a, 322b and 322c of the original sequence 3, while the position of the trigger pulses 321a, 321b and 321c remains unchanged.

The first and the third pair of pulses 42a and 42c of the transmitted sequence 4 have a relative temporal distance between their respective two pulses which is increased, respectively, by the positive offset value δa and δc with respect to the corresponding predefined relative temporal distance Ta and Tc of the original sequence. In practice, the second pulses 422a and 422c are delayed by δa and δc, respectively.

The second pair of pulses 42b, on the other hand, has a relative temporal distance that is decreased by δb (as an absolute value, considering that δb in the figure has a negative sign), and therefore the second pulse 422b of the pair is anticipated by |δb|with respect to the predefined temporal position of Tb microseconds from the preceding pulse 321b of the pair 32b of the original sequence 3.

In the second embodiment illustrated in FIG. 6B, the pulses in positions P3, P7 and P16 are the pulses that, in the transmitted sequence 6, are time-shifted with respect to their predefined positions of the original sequence 5. In particular, the pulses in positions P3 and P16 are respectively anticipated by an offset of δ3 and δ16, while the pulse in position P7 is delayed by an offset δ7.

Advantageously, in the transmitted sequence (e.g. 4 or 6) at least one of the time-shifted pulses shall be located, with respect to the pulse that precedes it, at at least one temporal position that does not correspond to any of the predefined temporal positions (T0+n·ΔT) that are provided in the PPM encoding, so as to prevent an unauthorized receiver from decoding any symbol from the time-shifted pulse.

For example, in the embodiment of FIG. 8, one or more of the time-shifted second pulses (e.g. pulse 422a′) of the transmitted sequence 4 is at a position TO+y, wherein y is different from n. AT and it is lower than (2\hat{ }M−1)·ΔT. In the non-limiting example, the position of the time-shifted pulse was T0+7·ΔT in the original sequence and, in the transmitted sequence, is T0+7·ΔT+δ′7, wherein δ′7 is lower than ΔT, is not an integer and is different from zero.

In the embodiment of FIG. 9, one or more of the second pulses (422a′) in the transmitted sequence 4 is shifted in time at a position T0+Y, wherein Y is higher than (2\hat{ }M−1)·ΔT, is lower than IFS and, preferably, is different from n·ΔT.

The encryption means 16 are advantageously adapted to encrypt with a symmetric key or with a public key at least one shift information item 71, 72, 73 which is then shared in encrypted form with the authorized receivers 2, in order to be able to decrypt the received PPM signal, i.e. restore the predefined temporal positions of the pulses that have been shifted and enable the decrypted PPM signal to be decoded.

By “shift information item” is meant a set of data that comprises at least the placement (P1, P2, P3 . . . ) of the time-shifted pulses within the original sequence 3, 5 or within the transmitted sequence 4, 6, and the respective extent of the shift i.e. the respective offset 8 (with a positive or negative sign) with respect to the predetermined temporal position, in the original sequence, of the pulse with that placement.

The shift information item 71, 72, 73 is stored in the transmitter 1 (in particular, in the microcontroller 15) or it can be generated by the microcontroller 15 using an algorithm.

The shift information item 71, 72, 73 can be advantageously inserted in encrypted form in the transmitted pulse sequence, for example by PPM encoding the shift information item encrypted with a symmetric key (or with a public key of the authorized receiver) and inserting the PPM pulses thus obtained into a portion (51b) of the preamble of the transmitted pulse sequence (6), for example in a portion 51b that follows the first two pulses 51a of the preamble at a fixed distance Tp.

The symmetric key is preferable in that it can be easily stored in all the authorized receivers 2, and optionally it can have an expiry date so that receivers 2 that are no longer authorized cannot decrypt the PPM signals without the new key.

Alternatively, the encryption means 16 can adopt an asymmetric-key encryption algorithm, in which for the encryption a public key of the receiver 2 authorized to decode the PPM signals transmitted by that transmitter is used. The authorized receiver 2 can use its corresponding private key to decrypt the signals.

In further embodiments of the invention, it is possible to have a set of shift information items 71, 72, 73 (i.e. a plurality of combinations of placements and offsets) which is shared in advance with all the authorized receivers (for example at the manufacturing stage). Each combination in the set is associated with an identifier S1, S2, . . . , Sn, so that the transmitted PPM signal 4 or 6 can also transport (for example encoded in PPM in a portion of the preamble 51b) the identifier S1, S2, . . . , Sn of the placement/offset combination used for the encryption of the value associated with the encoded symbol in that specific PPM signal. This identifier too can be encrypted with a symmetric key, or with a public key of the receiver 2, before encoding it with PPM modulation in the preamble 51b portion of the transmitted sequence.

The decryption means 23 of the receiver 2 are adapted to identify each pulse of the received sequence 4 or 6 (422a, 422b and 422c or P3, P7 and P16) that is time-shifted with respect to a predefined temporal position thereof, and to shift each pulse identified as time-shifted by the corresponding offset (δa, δb, δc or δ3, δ7, δ16, δ′7) so as to restore its predefined temporal position. By virtue of the decryption means 23, the original sequence of pulses 3 or 5 is obtained, and is adapted to be decoded with the PPM decoding means 24 in order to reconstruct the information 25 that was originally transmitted.

For example, the decryption means 23 can identify an identifier S1, S2, S3 encoded in a portion of the preamble 51b and, through the shift information items 71, 72, 73 which are stored in the authorized receiver 2, identify the key used to encrypt the received pulse sequence.

Alternatively, the decryption means 23 are adapted to decrypt, through the symmetric key or the private key of the receiver 2, a predefined portion of the received pulse sequence, for example a portion of the preamble 51b or a first part of the pulses of the received sequence after the preamble 31 or 51a, and extract from that portion the shift information item 71, 72 or 73 that was used for the encryption of that sequence or extract an identifier S1, S2 or S3 of one of a plurality of shift information items 71, 72, 73 which are stored in the authorized receiver 2.

The operation of the invention is evident from the foregoing description.

In order to perform the transmission of encrypted PPM symbols, a step of PPM encoding of an information item to be transmitted is executed, in which to each symbol of M bits of an alphabet of 2\hat{ }M symbols used to compose the information item to be transmitted is assigned a respective predefined temporal position of one pulse with respect to the preceding pulse of an original sequence of PPM pulses. An encryption step is also executed so that at least one of the pulses of the (RF) transmitted sequence is time-shifted, according to a corresponding offset (δa, δb, δc, δ3, δ7, δ16, δ′7) that is known only to authorized receivers, with respect to its predefined temporal position in the original sequence.

Each offset of a sequence of offsets applied to a given original sequence of pulses can be optionally generated by the encryption means 16 convolutedly, i.e. as a function of the preceding offset value of the sequence of offsets.

It is preferable that a plurality of the pulses of the transmitted sequence are time-shifted with respect to the respective predefined temporal position, with the corresponding offset having a value and/or a sign that preferably is not the same for all the pulses that have been shifted, so as to render abusive decoding even more difficult.

At the authorized receiver 2, prior to the PPM decoding, each pulse of the received sequence that is time-shifted with respect to a predefined temporal position thereof is identified, and each time-shifted pulse is shifted by a corresponding offset, known to the receiver, so as to restore its predefined temporal position and obtain an original sequence of pulses that is adapted to be decoded with PPM decoding.

In practice it has been found that the invention fully achieves the intended aim and objects.

The invention thus conceived is susceptible of numerous modifications and variations, all of which are within the scope of the appended claims. Moreover, all the details may be substituted by other, technically equivalent elements.

The disclosures in Italian Patent Application No. 102022000015990 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-23. (canceled)

24. A method of transmission of encrypted PPM signals for a radio communication system, particularly short-range radio, which comprises a step of PPM encoding of an item of information to be transmitted, in which each symbol of an alphabet of symbols used to compose the information item to be transmitted is assigned a respective predefined temporal position of one pulse with respect to the preceding pulse of an original sequence of PPM pulses, comprising an encryption step in which at least one of the pulses of the transmitted sequence is time-shifted, according to a corresponding offset which is known only to authorized receivers, with respect to its predefined temporal position in the original sequence, wherein said offset is such that the time-shifted pulse is not located, with respect to the pulse that precedes it, in any of the predefined temporal positions that are provided in said PPM encoding.

25. The method according to claim 24, wherein a plurality of said pulses of the transmitted sequence are time-shifted with respect to the respective predefined temporal position, with the corresponding offset preferably having a value and/or a sign that is not the same for all the pulses of said plurality of time-shifted pulses.

26. The method according to claim 24, wherein said encryption step comprises the encryption, with a symmetric key or a public key, of at least one shift information item or of an identifier of a shift information item taken from a set of predetermined shift information items which are known to authorized receivers, each shift information item comprising at least the placement in the original sequence or in the transmitted sequence of the time-shifted pulses and the corresponding offset with respect to the predetermined temporal position.

27. The method according to claim 26, wherein one of said encrypted shift information item, said encrypted identifier or said unencrypted identifier is transmitted with said encrypted PPM signal.

28. The method according to claim 27, wherein the encrypted PPM signal that is transmitted comprises a preamble and said transmitted sequence of pulses, said preamble containing said encrypted shift information item or said encrypted or unencrypted identifier.

29. The method according to claim 24, wherein said transmitted sequence of pulses comprises a plurality of temporally consecutive pairs of pulses, each pair comprising a first pulse which corresponds to said preceding pulse and a second pulse which, in at least one of said pairs, corresponds to said time-shifted pulse.

30. The method according to claim 29, wherein the first pulses of the pairs of pulses have a substantially constant spacing in the sequence or the second pulse of each pair corresponds to the first pulse of the subsequent pair in the sequence.

31. A method of receiving encrypted PPM signals for a radio communication system, particularly short-range radio, which comprises a step of PPM decoding of an encrypted PPM signal received by the receiver, wherein a respective symbol of an alphabet of symbols used in an encoding to compose the item of information to be transmitted with the PPM signal is obtained from a respective temporal position of one pulse with respect to the preceding pulse of a received sequence of pulses of the received PPM signal, characterized in that it comprises a decryption step in which, prior to the PPM decoding:
each pulse of the received sequence that is time-shifted with respect to a predefined temporal position thereof is identified;
each time-shifted pulse is shifted by a corresponding offset which is known to the receiver, so as to restore its predefined temporal position and obtain an original sequence of pulses that is adapted to be decoded with said PPM decoding, wherein said offset is such that the time-shifted pulse is not located, with respect to the pulse that precedes it, in any of the predefined temporal positions that are provided in PPM encoding.

32. The method according to claim 31, wherein said offset has a value and/or a sign that is not the same for all the time-shifted pulses.

33. The method according to claim 31, wherein said receiver comprises a shift information item or a set of predetermined shift information items which are known to the authorized receiver and can be identified by a respective identifier, each shift information item comprising at least the placement, in the original sequence or received sequence, of the time-shifted pulses and the corresponding offset with respect to the predefined temporal position.

34. The method according to claim 33, wherein either said shift information item or said identifier is received with said PPM signal in a form that is encrypted with a symmetric key or with a public key of the receiver, so that it can be decrypted with the symmetric key or a private key of the receiver, respectively.

35. The method according to claim 34, wherein the PPM signal that is received comprises a preamble and said received sequence of pulses, said preamble containing said shift information item in encrypted form or said identifier in encrypted or unencrypted form.

36. A transmitter of a radio communication system, particularly short-range radio, for encrypted PPM signals, which comprises PPM encoding means for encoding an information item to be transmitted which are adapted to assign, to each symbol of an alphabet of symbols used to compose the information item to be transmitted, a respective predefined temporal position of one pulse with respect to the preceding pulse of an original sequence of pulses, further comprising encryption means adapted to time-shift at least one of the pulses of the original sequence, according to a corresponding offset which is known only to authorized receivers, with respect to its predefined temporal position in the original sequence, so that the transmitted pulse sequence comprises said at least one time-shifted pulse, wherein said offset is such that the time-shifted pulse is not located, with respect to the pulse that precedes it, in any of the predefined temporal positions that are provided in said PPM encoding.

37. The transmitter according to claim 36, wherein a plurality of said pulses of the transmitted sequence are time-shifted by the encryption means with respect to the respective predefined temporal position, with the corresponding offset preferably having a value and/or a sign that is not the same for all the pulses of said plurality of time-shifted pulses.

38. The transmitter according to claim 36, wherein said encryption means are adapted to encrypt, with a symmetric key or a public key, at least one shift information item or an identifier of a shift information item taken from a set of predetermined shift information items which are known to authorized receivers, each shift information item comprising at least the placement in the original sequence or in the transmitted sequence of the time-shifted pulses and the corresponding offset with respect to the predefined temporal position.

39. The transmitter according to claim 38, wherein one of said encrypted shift information item, said encrypted identifier or said unencrypted identifier is transmitted with said encrypted PPM signal.

40. The transmitter according to claim 39, wherein the encrypted PPM signal that is transmitted comprises a preamble and said transmitted sequence of pulses, said preamble containing said encrypted shift information item or said encrypted or unencrypted identifier.

41. The transmitter according to claim 38, wherein said encryption means are adapted to generate the symmetric key or the public key used for the encryption.

42. A receiver of a radio communication system, particularly short-range radio, for encrypted PPM signals, which comprises PPM decoding means for decoding a received encrypted PPM signal, wherein a respective symbol of an alphabet of symbols used in an encoding to compose the information item to be transmitted with the PPM signal is obtained from a respective temporal position of one pulse with respect to the preceding pulse of a received sequence of pulses of the received PPM signal, characterized in that it comprises decryption means which are adapted to:
identify each pulse of the received sequence that is time-shifted with respect to a predefined temporal position thereof;
shift by a corresponding offset, known to the receiver, each pulse identified as time-shifted so as to restore its predefined temporal position and obtain an original sequence of pulses that is adapted to be decoded with said PPM decoding means, wherein said offset is such that the time-shifted pulse is not located, with respect to the pulse that precedes it, in any of the predefined temporal positions that are provided in PPM encoding.

43. The receiver according to claim 42, wherein said offset has a value and/or a sign that is not the same for all the time-shifted pulses.

44. The receiver according to claim 42, wherein a shift information item or a set of predetermined shift information items which can be identified by a respective identifier is stored, each shift information item comprising at least the placement, in the original sequence or received sequence, of the time-shifted pulses and the corresponding offset with respect to the predefined temporal position.

45. The receiver according to claim 44, wherein either said shift information item or said identifier is received with said PPM signal in a form that is encrypted with a symmetric key or with a public key of the receiver.

46. The receiver according to claim 45, wherein the PPM signal that is received comprises a preamble and said received sequence of pulses, said preamble containing said shift information item in encrypted form or said identifier in encrypted or unencrypted form.
